(19) United States
(12) Patent Application Publication
(10) Pub. No.: US 2023/0258952 A1
(43) Pub. Date: Aug. 17, 2023

(54) DISTORTION REDUCING OPTICS

(71) Applicant: Lumentum Operations LLC, San Jose, CA (US)

(72) Inventors: Michael MILLER, Ottawa (CA); Vincent V. WONG, Los Altos, CA (US); Paul COLBOURNE, Ottawa (CA); Lijun ZHU, Dublin, CA (US)

(21) Appl. No.: 17/937,219

(22) Filed: Sep. 30, 2022

Related U.S. Application Data
(63) Continuation-in-part of application No. 17/662,690, filed on May 10, 2022.
(60) Provisional application No. 63/367,192, filed on Jun. 28, 2022.
(60) Provisional application No. 63/268,141, filed on Feb. 17, 2022.

(51) Int. Cl. G02B 27/42; G02B 27/30; G01S 17/89; H04N 9/31

(52) U.S. Cl. CPC G02B 27/4205; G02B 27/30; G01S 17/89; H04N 9/31

(57) ABSTRACT

An optical device may include emitter array to emit light. The optical device may include a collimating element to create an image of the light emitted by the emitter array. The optical device may include a diffractive optical element (DOE) to generate a pattern from the image of the light. The optical device may include a distortion correction element to reduce distortion in the pattern on a screen or to shape the pattern on the screen.

### CROSS-REFERENCE TO RELATED APPLICATION

This Patent application claims priority to U.S. Provisional Patent Application No. 63/367,192, filed on Jun. 28, 2022, and entitled “DISTORTION REDUCING OPTICS.” This Patent Application also claims priority to U.S. patent application Ser. No. 17/662,690, filed on May 10, 2022, and entitled “OPTICAL SYSTEM FOR LIGHT DETECTION AND RANGING,” which claims priority to U.S. Provisional Patent Application No. 63/268,141, filed on Feb. 17, 2022, and entitled “OPTICS AND EMITTER CONFIGURATION FOR A ONE-DIMENSIONAL ADDRESSABLE VERTICAL CAVITY SURFACE EMITTING LASER ARRAY.” The disclosures of the prior Applications are considered part of and are incorporated by reference into this Patent Application.

### TECHNICAL FIELD

The present disclosure relates generally to an optical device and, more particularly, to an optical device including distortion reducing optics.

### BACKGROUND

An optical device, such as a dot projector or a light detection and ranging (LIDAR) device, may include an emitter chip comprising an active area of emitters (i.e., an emitter array) and other optics that enable the optical device to project an image (e.g., a patterned image) of the active area of emitters on a screen located in the far-field (FF) within a field-of-view (FOV). Such a device can be used, for example, in a three-dimensional (3D) sensing application or a LIDAR application, among other examples.

### SUMMARY

In some implementations, an optical device includes an emitter array to emit light; a collimating element to create an image of the light emitted by the emitter array; a diffractive optical element (DOE) to generate a pattern from the image of the light; and a distortion correction element to reduce distortion in the pattern on a screen or to shape the pattern on the screen.

In some implementations, a device includes a collimating element to create an image from light emitted by an emitter array; a DOE to generate a pattern from the image; and a distortion correction element to reduce distortion in the pattern or to shape the pattern.

In some implementations, a method comprises: creating an image from light emitted by an emitter array, the light being collimated by a collimating element of an optical device; generating a pattern from the image, the pattern being generated by a DOE of the optical device; and manipulating the pattern on a screen, the pattern being manipulated by a distortion correction element of the optical device.

### BRIEF DESCRIPTION OF THE DRAWINGS

FIGS. 1A-1C are diagrams illustrating examples associated with a conventional dot projector.

FIG. 2 is a diagram illustrating and example of an optical device including distortion correction optics, as described herein.

FIGS. 3A and 3B are diagrams illustrating an example of a phase profile of a distortion correction element described herein and a pattern resulting from distortion reduction provided by the distortion correction element described herein.

FIGS. 4A and 4B are diagrams illustrating an example of distortion reduction in a LIDAR device including a distortion correction element, as described herein.

FIG. 5 is a flowchart of an example process associated with operation of an optical device including distortion reducing optics, as described herein.

### DETAILED DESCRIPTION

The following detailed description of example implementations refers to the accompanying drawings. The same reference numbers in different drawings may identify the same or similar elements.

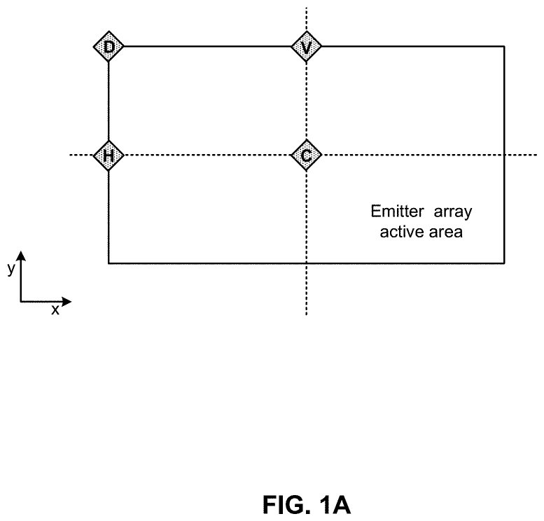

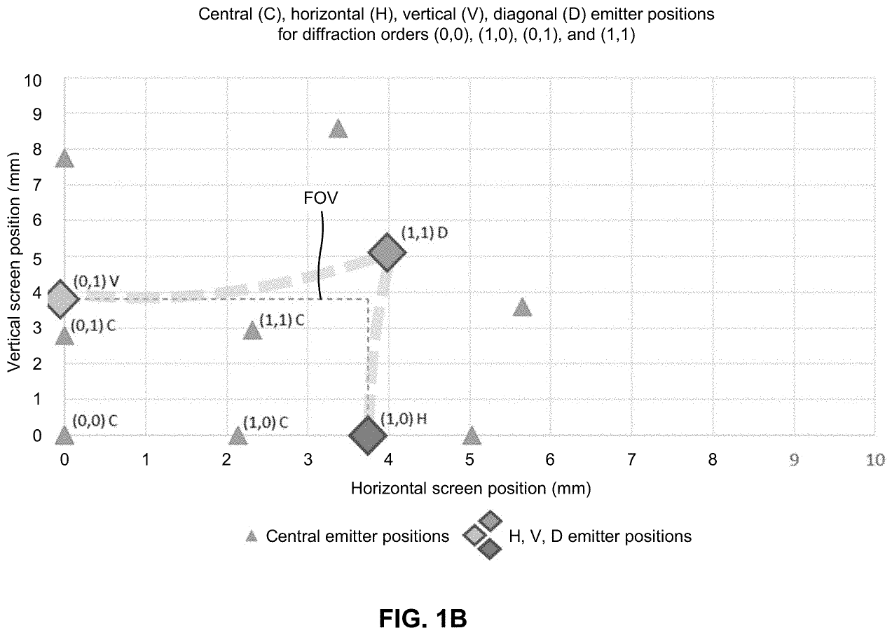

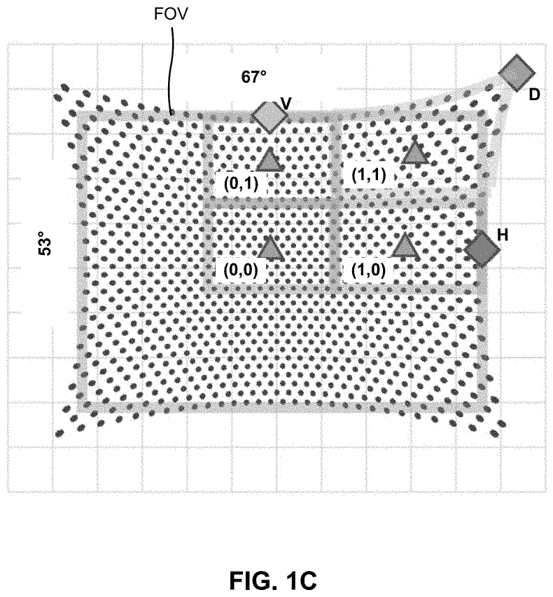

A conventional dot projector is based on three optical components: (1) an emitter chip (e.g., a vertical-cavity surface-emitting laser (VCSEL) chip) comprising an active area of a set of emitters (i.e., an emitter array) that are spaced in a pattern (e.g., a hexagonal pattern), (2) a collimating lens (CL) to create an image of the active area (also referred to as a central tile) on a screen located in the FF (e.g., in a range from 0.5 meters (m) to 10.0 m from the dot projector), and (3) a tiling DOE to step and repeat the central tile in an X×Y grid (e.g., a 3×3 grid) in the horizontal and vertical directions at the screen (relative to the central tile). The step and repeating of the central tile generates a dot pattern in an FOV having a horizontal dimension and a vertical dimension. In general, with reference to FIG. 1A, the extent of a given tile at the screen is defined by off-axis emitters (relative to a central (C) emitter) at edges of the active area of the emitter array—a horizontal (H) emitter, a vertical (V) emitter, and a diagonal (D) emitter. However, in the conventional dot projector, distortion may affect the pattern at the screen. For example, distortion may reduce a quantity of dots in the pattern that fall within a desired FOV. As another example, distortion may cause the shape of dots in the pattern to negatively impacted (e.g., distortion may cause dot shapes to be non-uniform where dot shape uniformity is desired). As another example, distortion may cause spacing of dots in the pattern to be negatively impacted (e.g., distortion may cause dot spacing to be non-uniform where dot spacing uniformity is desired).

In general, distortion can be classified as negative distortion (also referred to as barrel distortion), where some dots in the pattern appear too close to a center of the FOV, or positive distortion(also referred to as pin-cushion distortion), where some dots in the pattern appear too far from the center of the FOV. An amount (e.g., a percentage) of distortion can be determined based on an actual distance (AD) from the center of the FOV to a point on an edge of the image and a predicted distance (PD) from the center of the FOV to the point on the edge of the image (e.g., % distortion=([AD−PD]/PD)×100%). In a conventional dot projector, the distortion for FOVs of approximately 70 degrees)(°) by approximately 50° (H×V) and larger produces a pin-cushion distortion.

Typically, the FOV comprises a low number of tiles, such as nine tiles (e.g., X×Y=3×3) that are generated by diffraction orders of the tiling DOE. In such a configuration, the diffraction order angles of the m^{th} H and n^{th} V orders (i.e., (m, n)=(1,0) and (m, n)=(0,1)), that define the FOV are on the order of approximately 25° to approximately 30°. Such diffraction order angles lead to a tiling DOE unit cell or pitch dimension of a few microns, which can be determined from the following grating equation:

$$Sin {θ}_{m , n} = λ \cdot \sqrt{{( \frac{m}{{d}_{H}} )}^{2} + {( \frac{n}{{d}_{V}} )}^{2}} + Sin {θ}_{I} \qquad ( Equation 1 )$$

where θ₁ is the incident angle, m and n are the diffraction order indexes in the H and V directions, respectively, θ_{m,n} is the diffraction order angle, d_{H} and dᵥ are the DOE unit cell dimensions, and λ is the wavelength of illumination. Once the H and V DOE unit cell dimensions are known, the diffraction order angles or (x,y) positions of the D orders ((m, n)=(±1, ±1)) can be deduced. As described below, a significant contributor to pin-cushion distortion is the diffraction order angle/screen position of a D emitter in the D diffraction orders. Furthermore, since a surface of the emitter array may be positioned close to an effective focal length of the CL, the incidence angle θ₁ of the off-axis emitters can be approximated by a value e_{d}/ƒ, where e_{d} is a distance from a center of the emitter chip to a given emitter and ƒ is the focal length of the CL.

FIG. 1B is a diagram illustrating an example of positions of dots on a screen calculated using Equation 1 for orders and emitters of interest, namely, orders (m, n)=(1,0), (0,1) and (1,1), and the H, V, and D emitters of an example emitter chip with an active area chosen for a FOV of 53°×67°. As mentioned above, and as indicated in FIG. 1B, the horizontal aspect of the FOV is defined by a screen position of the H emitter in the (m, n)=(1,0) order and the vertical aspect of the FOV is defined by a screen position of a V emitter for the (m, n)=(0,1) order. Furthermore, the pin-cushion distortion of the dot pattern is due to the diffraction angle/screen position of the D emitter in the diagonal (m, n)=(1,1) order. This is caused by the diffraction angle of the D emitter being larger than those of the H or V emitters in the (m, n)=(1,0), (0,1) orders due to the order index (m, n)=(1,1) and D emitter incidence angle (e_{d}), both of which determine the diffraction angle. A similar dot pattern simulated for the same example active area with a 17 micron (μm) optical aperture (OA) is shown in FIG. 1C. As shown in FIG. 1C, a pin-cushion distortion as predicted by Equation 1 is present. In the example shown in FIG. 1C, the distortion is approximately equal to 18.4%. As shown in FIGS. 1B and 1C and as noted above, such high distortion causes a quantity of dots within the desired FOV to decrease, causes dot shape to be non-uniform within the pattern (e.g., dots near the corners of the FOV are distorted), and causes spacing among the dots to be non-uniform.

Some implementations described herein provide an optical device comprising distortion reducing optics. In some implementations, the optical device includes an emitter to emit light, a collimating element to create an image of the light emitted by the emitter, and a DOE to generate a pattern from image of the light. The optical device further includes a distortion correction element. In some implementations, the distortion correction element reduces distortion in the pattern on a screen. Additionally, or alternatively, the distortion correction element may shape the pattern on the screen. In some implementations, the distortion correction element may be utilized to reduce distortion in a pattern and/or to shape the pattern, thereby increasing a quantity of dots within a desired FOV, decreasing an impact of distortion on dot shape in the pattern (e.g., increasing dot shape uniformity in the pattern), and decreasing an impact of distortion on dot spacing in the pattern (e.g., increasing dot spacing uniformity in the pattern) which, in turn, improves performance of an application that utilizes the pattern (e.g., a 3D sensing application, a LIDAR application, or the like).

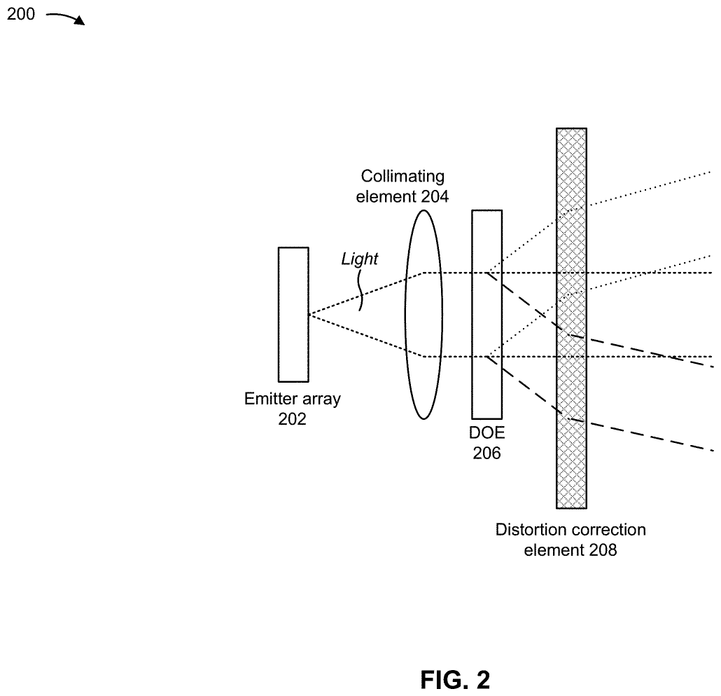

FIG. 2 is a diagram illustrating an example of an optical device 200 including distortion correction optics, as described herein. As shown in FIG. 2, the optical device 200 may include an emitter array 202, a collimating element 204, a DOE 206, and a distortion correction element 208. In some implementations, the optical device 200 may be a dot projector, a LIDAR device, or another type of optical device designed to provide structured light.

The emitter array 202 is an emitter array to emit light (e.g., one or more beams of light) from which a pattern is to be generated at a screen. For example, the emitter array 202 may include a VCSEL chip comprising an active area with a plurality of VCSELs. Each emitter of the emitter array 202 may provide a respective beam of light (e.g., for illustrative purposes, a beam of light from a single emitter of the emitter array 202 is shown in FIG. 1). As another example, the emitter array 202 may comprise a single source laser (e.g., an edge-emitting laser (EEL)). In some implementations, the emitter array 202 is a bottom-emitting VCSEL array comprising a plurality of bottom-emitting VCSELs (i.e., emitters of emitter array 202 may emit light through a substrate side of the emitter array 202). In some implementations, the emitter array 202 is a top-emitting VCSEL array comprising a plurality of top-emitting VCSELs (i.e., emitters of emitter array 202 may emit light through a non-substrate side of the emitter array 202). In some implementations, the emitter array 202 is a one-dimensional (1D) array of emitters. In some implementations, the emitter array 202 is a two-dimensional (2D) array of emitters.

The collimating element 204 is an element to collimate the light emitted by the emitter array 202. For example, the collimating element 204 may receive light emitted by the emitter array 202 and may collimate the light to create an image of the emitter array 202 on a screen (not shown) located in the FF of the optical device 200 (e.g., in a range from approximately 0.5 m to approximately 10.0 m from the optical device 200).

The DOE 206 is an element to generate a pattern from the image created by the collimating element 204. For example, the DOE 206 may in some implementations be a tiling DOE designed to step and repeat the image of the emitter array 202 (i.e., the central tile) in an X×Y grid (e.g., a 3×3 grid) in the horizontal and vertical directions at the screen. As another example, the DOE 206 may in some implementations be a diffuser (e.g., a 1D diffuser, a 2D diffuser) designed to spread the image of the emitter array 202 in one or more dimensions.

The distortion correction element 208 is an element that manipulates the pattern generated by the DOE 206. For example, in some implementations, the distortion correction element 208 may reduce distortion in the pattern on the screen. Additionally, or alternatively, the distortion correction element 208 may shape the pattern on the screen. In some implementations, as shown in FIG. 2, the distortion correction element 208 is after the DOE 206 on an optical path of the optical device 200. In some implementations, the distortion correction element 208 has a free-form shape, a radially symmetric shape, or a biconvex shape. Manipulation of the pattern by the distortion correction element 208 is provided by a phase profile of the distortion correction element 208. In some implementations, the phase profile of the distortion correction element 208 is realized with meta-material surfaces, a continuous surface relief profile, a Fresnel profile, a binary surface relief profile, or a multi-level surface relief profile. In some implementations, the distortion correction element 208 may be a discrete element (e.g., the distortion correction element 208 may not be integrated or combined with the collimating element 204 or the DOE 206).

In some implementations, one or more elements of the optical device 200 may be combined or integrated. For example, in some implementations, the DOE 206 may be on a first surface of an optical substrate and the distortion correction element 208 may be on a second (opposite) surface of the optical substrate (e.g., such that the optical substrate has two patterned surfaces). As another example, in some implementations, the DOE 206 and the collimating element 204 may be on a first surface of an optical substrate and the distortion correction element 208 may be on a second (opposite) surface of the optical substrate. In some implementations, the DOE 206 and the collimating element 204 may be combined on a single surface using multi-level or meta-surface DOEs, which can reduce an optics length of the optical device 200 (e.g., in a range from approximately 1 mm to approximately 2 mm). As another example, in some implementations, one or more of the collimating element 204, the DOE 206, and the distortion correction element 208 (e.g., a diffuser) may be integrated into the same substrate (e.g., a gallium arsenide (GaAs) substrate) as an emitter array 202 (e.g., a VCSEL chip). In one particular example implementation, the emitter array 202 (e.g., the VCSEL chip) may be integrated with a collimating element 204 (e.g., collimating lens) on the same substrate, and the DOE 206 and the distortion correction element 208 are on a first surface and a second (opposite) surface, respectively, of a separate optical element.

Notably, the optical device 200 described herein is not limited to correcting pin-cushion distortion emanating from the DOE 206. That is, the optical device 200 can be designed to correct barrel distortion that may be present in a pattern generated with a different optical configuration (e.g., an optical device that includes single surface components based on the Talbot-Lau effect).

As indicated above, FIG. 2 is provided as an example. Other examples may differ from what is described with regard to FIG. 2. The number and arrangement of elements shown in FIG. 2 are provided as an example. In practice, there may be additional elements, fewer elements, different elements, or differently arranged elements than those shown in FIG. 2. Furthermore, two or more elements shown in FIG. 2 may be implemented within a single element, or a single element shown in FIG. 2 may be implemented as multiple, distributed elements. Additionally, or alternatively, a set of elements (e.g., one or more elements) shown in FIG. 2 may perform one or more functions described as being performed by another set of elements shown in FIG. 2.

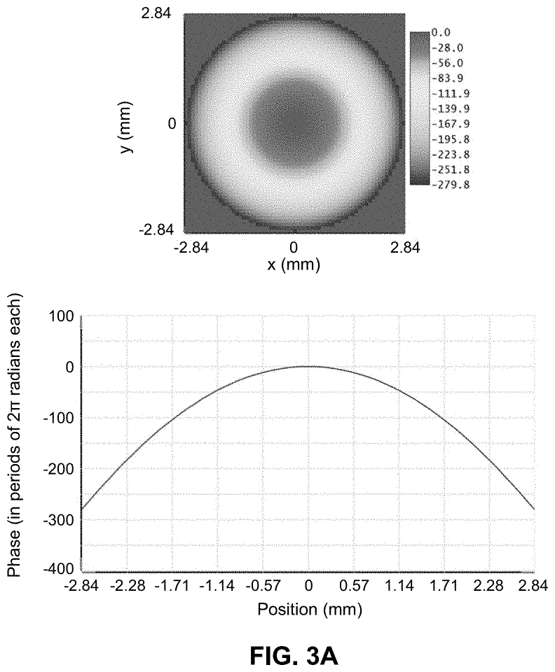

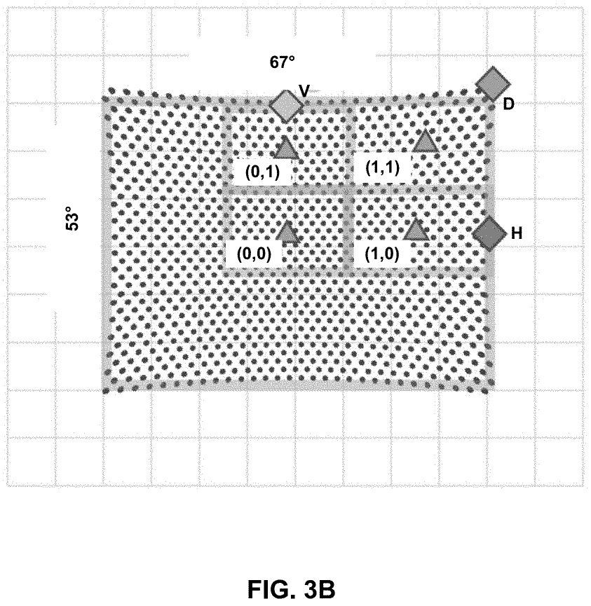

In one example implementation, the distortion correction element 208 can significantly reduce distortion in a pattern (e.g., to less than or equal to approximately 5%) to realize a pattern with a comparatively more rectangular shape (e.g., a pattern that better fits the FOV), while decreasing an impact of distortion on dot shape (e.g., increasing dot shape uniformity) and decreasing an impact of distortion on dot spacing (e.g., increasing dot spacing uniformity). As one example, a distortion correction element 208 may be designed so as to reduce distortion to approximately 5.4% from 18.4% (e.g., as compared to the conventional dot projector described in the above example). FIGS. 3A and 3B are diagrams illustrating an example of a phase profile of such a distortion correction element 208 and a pattern resulting from distortion reduction provided by the distortion correction element 208. As illustrated in FIG. 3A, the phase profile of the distortion correction element 208 in this example is similar to that of a convex lens (e.g., since diffraction angles of the off-axis emitters in the D diffraction orders are being reduced). Further, as can be seen by comparing FIG. 3B and FIG. 1C, the distortion in the pattern is significantly reduced by the distortion correction element 208 (e.g., the pattern is comparatively more rectangular, dot shape uniformity is increased, dot spacing uniformity is increased, and a quantity of dots within the FOV is increased). The phase profile and resulting pattern shown in FIGS. 3A and 3B are provided as illustrative examples, and other (e.g., non-radially symmetric) phase or surface profiles can be utilized to reduce distortion in a similar manner.

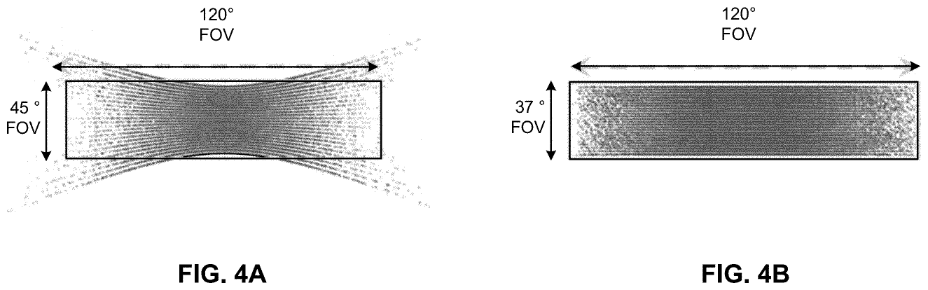

In some implementations, a distortion correction element 208 may be utilized to reduce pin-cushion type distortion in a LIDAR device. FIGS. 4A and 4B are diagrams illustrating an example of distortion reduction in a LIDAR device. In such a device, the DOE 206 may be a 1D diffuser (which can be viewed as a 1D diffraction grating). Such an optical device 200 generates pin-cushion distortion in the FF and on a flat screen, an example of which is illustrated in the diagram of FIG. 4A. However, with a distortion correction element 208 (e.g., a rotationally symmetric even aspherical front surface and a freeform extended polynomial back surface), the distortion can be significantly reduced, as illustrated in the example shown in FIG. 4B. Furthermore, the distortion correction element 208 allows aberrations in the pattern at edges of the FOV to be corrected, as can be seen in FIG. 4B. As indicated above, FIGS. 4A and 4B are provided as examples. Other examples may differ from what is described with regard to FIG. 4.

In some implementations, a distortion correction element 208 may be utilized to shape a pattern for a cylindrical or spherical screen. For example, a LIDAR device may include a DOE 206 in the form of a 1D diffuser, and may be designed to utilize a cylindrical or spherical screen. In some implementations, the distortion correction element 208 may be utilized to shape the pattern such that the pattern is comparatively more rectangular (to better match the FOV) which, in turn, improves illumination at a detector array included in receiver optics of the optical device 200.

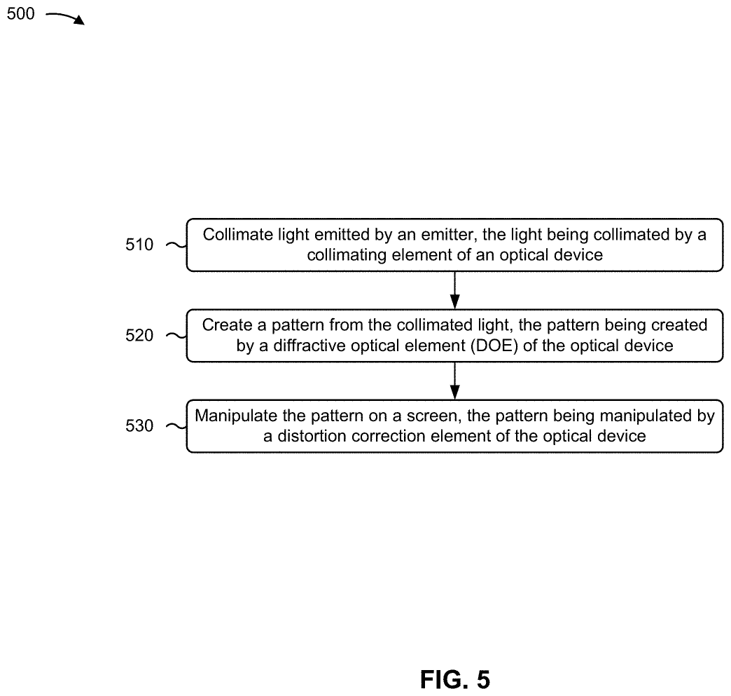

FIG. 5 is a flowchart of an example process 500 associated with operation of an optical device including distortion reducing optics. In some implementations, one or more process blocks of FIG. 5 are performed by an optical device (e.g., optical device 200). In some implementations, one or more process blocks of FIG. 5 may be performed by one or more components of the optical device 200, such as the emitter array 202, the collimating element 204, the DOE 206, and/or the distortion correction element 208.

As shown in FIG. 5, process 500 may include creating an image from light emitted by an emitter array (block 510). For example, the collimating element 204 of the optical device 200 may create an image from light emitted by an emitter array 202, as described above.

As further shown in FIG. 5, process 500 may include generating a pattern from the image (block 520). For example, the DOE 206 of the optical device 200 may generate a pattern from the image, as described above.

As further shown in FIG. 5, process 500 may include manipulating the pattern on a screen (block 530). For example, the distortion correction element 208 may manipulate the pattern on a screen, as described above.

Process 500 may include additional implementations, such as any single implementation or any combination of implementations described below and/or in connection with one or more other processes described elsewhere herein.

In a first implementation, manipulating the pattern comprises reducing distortion in the pattern on the screen.

In a second implementation, alone or in combination with the first implementation, manipulating the pattern comprises shaping the pattern on the screen.

In a third implementation, alone or in combination with one or more of the first and second implementations, the DOE 206 is on a first surface of an optical substrate and the distortion correction element 208 is on a second surface of the optical substrate.

In a fourth implementation, alone or in combination with one or more of the first through third implementations, the DOE 206 and the collimating element 204 are on a first surface of an optical substrate and the distortion correction element 208 is on a second surface of the optical substrate.

In a fifth implementation, alone or in combination with one or more of the first through fourth implementations, the distortion correction element 208 is a discrete element.

In a sixth implementation, alone or in combination with one or more of the first through fifth implementations, the distortion correction element 208 has a free-form shape, a radially symmetric shape, or a biconvex shape.

In a seventh implementation, alone or in combination with one or more of the first through sixth implementations, a phase profile of the distortion correction element 208 is realized with meta-material surfaces, a continuous surface relief profile, a Fresnel profile, a binary surface relief profile, or a multi-level surface relief profile.

In an eighth implementation, alone or in combination with one or more of the first through seventh implementations, the optical device 200 is a dot projector.

In a ninth implementation, alone or in combination with one or more of the first through seventh implementations, the optical device 200 is a LIDAR device.

Although FIG. 5 shows example blocks of process 500, in some implementations, process 500 includes additional blocks, fewer blocks, different blocks, or differently arranged blocks than those depicted in FIG. 5. Additionally, or alternatively, two or more of the blocks of process 500 may be performed in parallel.

The foregoing disclosure provides illustration and description, but is not intended to be exhaustive or to limit the implementations to the precise forms disclosed. Modifications and variations may be made in light of the above disclosure or may be acquired from practice of the implementations. Furthermore, any of the implementations described herein may be combined unless the foregoing disclosure expressly provides a reason that one or more implementations may not be combined.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”). Further, spatially relative terms, such as “below,” “lower,” “above,” “upper,” and the like, may be used herein for ease of description to describe one element or feature's relationship to another element(s) or feature(s) as illustrated in the figures. The spatially relative terms are intended to encompass different orientations of the apparatus, device, and/or element in use or operation in addition to the orientation depicted in the figures. The apparatus may be otherwise oriented (rotated 90 degrees or at other orientations) and the spatially relative descriptors used herein may likewise be interpreted accordingly.

What is claimed is:

1. An optical device, comprising:
an emitter array to emit light;
a collimating element to create an image of the light emitted by the emitter array;
a diffractive optical element (DOE) to generate a pattern from the image of the light; and
a distortion correction element to reduce distortion in the pattern on a screen or to shape the pattern on the screen.

2. The optical device of claim 1, wherein the DOE is on a first surface of an optical substrate and the distortion correction element is on a second surface of the optical substrate.

3. The optical device of claim 1, wherein the DOE and the collimating element are on a first surface of an optical substrate and the distortion correction element is on a second surface of the optical substrate.

4. The optical device of claim 1, wherein the distortion correction element is a discrete element.

5. The optical device of claim 1, wherein the distortion correction element has a free-form shape, a radially symmetric shape, or a biconvex shape.

6. The optical device of claim 1, wherein a phase profile of the distortion correction element is realized with meta-material surfaces, a continuous surface relief profile, a Fresnel profile, a binary surface relief profile, or a multi-level surface relief profile.

7. The optical device of claim 1, wherein the optical device is a dot projector.

8. The optical device of claim 1, wherein the optical device is a light detection and ranging (LIDAR) device.

9. A device, comprising:
a collimating element to create an image from light emitted by an emitter array;
a diffractive optical element (DOE) to generate a pattern from the image; and
a distortion correction element to reduce distortion in the pattern or to shape the pattern.

10. The device of claim 9, wherein the DOE and the distortion correction element are on opposite surfaces of an optical substrate.

11. The device of claim 9, wherein the DOE and the collimating element are combined on a single surface of an optical substrate and the distortion correction element is on another surface of the optical substrate.

12. The device of claim 9, wherein the distortion correction element is a discrete element.

13. The device of claim 9, wherein the distortion correction element has a free-form shape, a radially symmetric shape, or a biconvex shape.

14. The device of claim 9, wherein a phase profile of the distortion correction element is realized with meta-material surfaces, a continuous surface relief profile, a Fresnel profile, a binary surface relief profile, or a multi-level surface relief profile.

15. The device of claim 9, wherein the DOE is a tiling DOE, a one-dimensional diffuser, or a two-dimensional diffuser.

16. A method comprising:
creating an image from light emitted by an emitter array, the light being collimated by a collimating element of an optical device;
generating a pattern from the image, the pattern being generated by a diffractive optical element (DOE) of the optical device; and
manipulating the pattern on a screen, the pattern being manipulated by a distortion correction element of the optical device.

17. The method of claim 16, wherein manipulating the pattern comprises reducing distortion in the pattern on the screen.

18. The method of claim 16, wherein manipulating the pattern comprises shaping the pattern on the screen.

19. The method of claim 16, wherein the DOE is on a first surface of an optical substrate and the distortion correction element is on a second surface of the optical substrate.

20. The method of claim 16, wherein the DOE and the collimating element are on a first surface of an optical substrate and the distortion correction element is on a second surface of the optical substrate.
